(19) United States
(12) Patent Application Publication
(10) Pub. No.: US 2025/0238890 A1
(43) Pub. Date: Jul. 24, 2025

(54) VALET SERVICE MANAGEMENT SYSTEM

(71) Applicant: Christopher Hawkins, Dallas, TX (US)

(72) Inventor: Christopher Hawkins, Dallas, TX (US)

(21) Appl. No.: 18/420,946

(22) Filed: Jan. 24, 2024

(51) Int. Cl. G06Q 50/40; G08G 1/123

(52) U.S. Cl. CPC G06Q 50/40; G08G 1/123

(57) ABSTRACT

A system for managing a valet service is disclosed, the system including at least one user computing device in operable connection with a user network. An application server is in operable communication with the user network to host an application program for managing a valet service. The application program includes a user interface module for providing access to the application program via the at least one user computing device. A processor and a non-transitory, computer readable memory storing instructions that, when executed by the processor upon a user selection, cause the device to enable the management of one or more customer payment systems, parking statistics, a workflow, a scheduling module, and a payroll.

### CROSS-REFERENCE TO RELATED APPLICATION

The present application claims priority to U.S. Provisional Application No. 63/432,912 filed Dec. 15, 2022, titled “VALET SERVICE MANAGEMENT SYSTEM” which is hereby incorporated by reference in its entirety.

### TECHNICAL FIELD

The embodiments disclosed herein generally relate to systems and methods for managing valet services.

### BACKGROUND

Existing systems for managing valet services lack the functionality to allow customer users and employee users to communicate with one another, send requests, make payments, capture, and store photo or video, or the like. These systems lack functionality for allowing account holder users to monitor employee user activity and allow for employee-to-employee communication.

### SUMMARY OF THE INVENTION

This summary is provided to introduce a variety of concepts in a simplified form that is further disclosed in the detailed description of the embodiments. This summary is not intended for determining the scope of the claimed subject matter.

A system for managing a valet service is disclosed, the system including at least one user computing device in operable connection with a user network. An application server is in operable communication with the user network to host an application program for managing a valet service. The application program includes a user interface module for providing access to the application program via the at least one user computing device. A processor and a non-transitory, computer readable memory storing instructions that, when executed by the processor upon a user selection, cause the device to enable the management of one or more customer payment systems, parking statistics, a workflow, a scheduling module, and a payroll.

In one aspect, the system includes at least one account holder device, and at least one employee device.

In one aspect, the system includes at least one remote source in operable communication with each of the account holder device, the at least one employee device, and the at least one user device.

In one aspect, the tracking module manages the customer payment systems, the payroll, and parking statistics.

In one aspect, a location module monitors the location of the user, a vehicle, or an employee.

In one aspect, the tracking module and the location module permit the management of a valet service owner, a valet service employee, and a valet service customer.

In one aspect, the tracking module and the location module permit the tracking of vehicles in real-time.

In one aspect, a retail shop allows for the account holder to purchase valet equipment.

In one aspect, the system enables ticketless parking voucher transactions.

The disclosed system integrates valet customers, operators, and owners into a single system. The system may manage customer payment systems, parking statistics, workflow, scheduling, jobsites, payroll, communication between employees, ticketless vouchers, and service reviews.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a system architecture diagram of the network infrastructure, according to some embodiments;

FIG. 2 illustrates a block diagram of the application program in communication with the computing system, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The disclosed system combines may be a system, method, apparatus, software application for a mobile device such as a smartphone, the system may be downloadable and installable onto a smartphone of a valet service owner, valet service employee, or valet service customer.

The system may include service-centric functionality including tracking of vehicles in real time for any number of job sites, garages, parking lots, and the like. The system may include employee scheduling and tracking, employee workload metrics, and the like.

As user herein, the term “user” may be used to describe customers, account holders, garage owners, event managers, parking lot owners, employees, and the like.

The system may include employee-centric functionality including employee clock in, GPS location of employee devices, employee tracking, customer tipping of employees, tip pooling, and employee to employee communication, including but not limited to walkie talkie capabilities.

The system may include customer-centric functionality including systems for allowing customers of valet parking to use QR code functionality for vehicle valeting, communicate with service employees, capture and upload photos or videos of their vehicles and valuables prior to submitting their vehicle to a valet service, transfer of funds to a valet service provider for valet charges, transfer of funds to other service users to pay for valet charges, requests for item retrieval from a user's vehicle, and the like.

In practice and in use, the system may allow for scanning of a customer users copy of the application running on their smart device, such as via QR code scanning, or entering of the customer users phone number into the system to generate a virtual parking ticket which may appear within the customer users copy of the application. If it is the case that the customer user does not currently have the system installed on their smart device, the service provider may send, via text message, SMS, or the like, a message to the customer user smart device including the option to download and install the application on their smart device. Either an employee user or customer user may enter the customer user's information within the system including, but not limited to, customer phone number, vehicle details, vehicle ticket details, and the like. Either user may have the option to capture and upload photo or video relating to the vehicle and which may be associated with the user customers account on the system.

In some embodiments, customers may input search criteria to appeal to valet companies to compete for an event which the customer is holding. The valet companies may view the job or event posting and bid on the event.

In some embodiments, the system includes a retail shop for an account holder to purchase valet equipment.

In some embodiments, the user may utilize a camera in communication with a smart device (i.e., a smartphone) to capture an image of a license plate. The system will optically analyze the license plate characters (i.e., numbers, letters, and other identifying features) to retrieve prior stored information and the profile associated with the license plate.

A service provider account or account holder may view status of any number of customer vehicles including live statuses such as parked, in transit, repark, VIP, accepted, arrived, complete, or refund. A service provider account may view payment details and payment amounts as well as details relating to employee users who are in transit with a customer vehicle, arrival valet parker details, departure valet parker details, ticket writer details, and which employees have performed item retrieval requests submitted through the system. Service provider accounts may monitor employee user timing, efficacy, and location. Service provider accounts may also be configured to allow for communication between service provider accounts and employee user accounts.

Employee users may use the system to communicate with customer users via text her phone call and may receive customer user payment via cash, credit card, or digital payment systems.

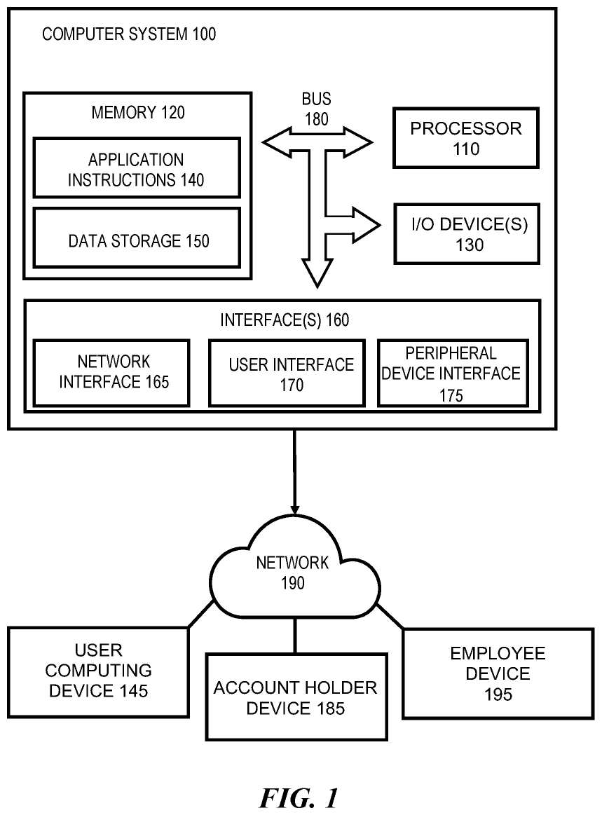

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

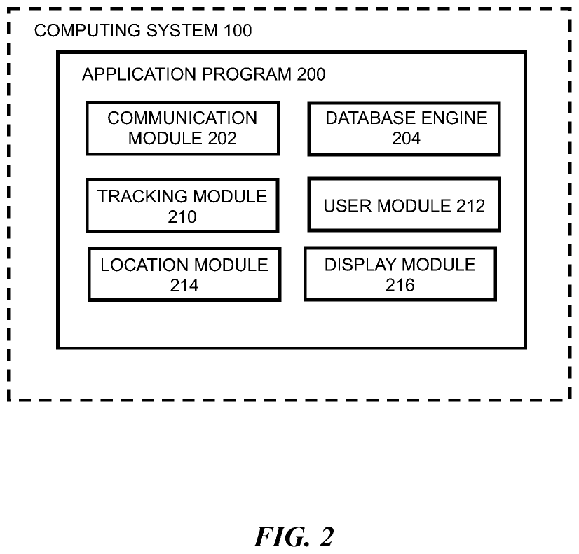

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a tracking module 210, a user module 212, a location module 214, and a display module 216.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195. In some embodiments, the communication module 202 allows each user to transmit and receive information which may be used by the system.

In some embodiments, the communication module 202 may allow for the communication between the user device, the employee devices and the account holder devices. The communication of information may include employee clock in, GPS location of employee devices, employee tracking, customer tipping of employees, tip pooling, and employee to employee communication, including but not limited to walkie talkie capabilities.

In some embodiments, the communication module 202 may provide customer-centric functionality including systems for allowing customers of valet parking to use QR code functionality for vehicle valeting, communicate with service employees, capture and upload photos or videos of their vehicles and valuables prior to submitting their vehicle to a valet service, transfer of funds to a valet service provider for valet charges, transfer of funds to other service users to pay for valet charges, requests for item retrieval from a user's vehicle, and the like.

In some embodiments, employee users may use the system to communicate, via the communication module, with customer users via text her phone call and may receive customer user payment via cash, credit card, or digital payment systems.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations. The database engine 204 allows each user and module associated with the system to transmit and receive information stored in various databases.

The database engine 204 allows users to access various data, via the display module 216, related to the valet service. For example, service provider account or account holder may view status of any number of customer vehicles including live statuses such as parked, in transit, repark, VIP, accepted, arrived, complete, or refund. A service provider account may view payment details and payment amounts as well as details relating to employee users who are in transit with a customer vehicle, arrival valet parker details, departure valet parker details, ticket writer details, and which employees have performed item retrieval requests submitted through the system. Service provider accounts may monitor employee user timing, efficacy, and location. Service provider accounts may also be configured to allow for communication between service provider accounts and employee user accounts.

In some embodiments, the tracking module 210 is operable to scan a QR code to display a profile and hide their number. Employees can communicate with customers and staff as well as protect the valet company from insurance fraud by storing photos/videos when needed. The system may also offer a scheduler for shifts, as well as utilized GPS clock in and out functions.

In some embodiments, the user module 212 facilitates the creation of a user account for the application system. The user module 212 may allow the user to input account information, establish user permissions and the like. The user module 212 may encompass various user profiles including employee profiles, account holder profiles, etc.

In some embodiments, the location module 216 allows for the tracking of the various tasks of the valet service in relation to the location of the tasks being performed. The tracking module 216 may track user activities, task activities, vehicles, etc.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for managing a valet service, the system comprising:
at least one user computing device in operable connection with a user network;
an application server in operable communication with the user network, the application server configured to host an application program for managing a valet service, the application program having a user interface module for providing access to the application program via the at least one user computing device;
a processor and a non-transitory, computer readable memory storing instructions that, when executed by the processor upon a user selection, cause the device to:
receive and store vehicle data from a user computing device;
register the vehicle data within a tracking module;
track vehicle location and user activity in real-time via a location module; and
manage workflows, employee scheduling, and payroll via a scheduling module, wherein the system integrates multiple user roles including valet customers, valet service employees, and service providers in a unified platform for real-time valet management.

2. The system of claim 1, further comprising at least one account holder device, wherein the account holder device comprises a computing device operable to receive live vehicle data, initiate service requests, and communicate with employee devices over the user network.

3. The system of claim 2, further comprising at least one employee device, wherein the at least one employee device is configured to receive assignments, clock in via GPS location data, and capture media files associated with a valet service session.

4. The system of claim 3, further comprising at least one remote source in operable communication with each of the account holder device, the at least one employee device, and at least one user device.

5. The system of claim 1, further comprising a tracking module to manage the customer payment systems, the payroll, and parking statistics.

6. The system of claim 1, further comprising a location module to monitor the location of a user, a vehicle, or an employee.

7. The system of claim 1, wherein the tracking module and the location module permit the management of a valet service owner, a valet service employee, and a valet service customer.

8. The system of claim 1, wherein the tracking module and the location module permit the tracking of vehicles in real-time.

9. The system of claim 1, further comprising a retail shop for the account holder to purchase valet equipment.

10. The system of claim 1, wherein the system enables ticketless parking voucher transactions.

11. A method for managing a valet service, the system comprising:
managing, via a database module of an application program operating on a server, at least one of a customer payment system, parking statistics, workflows, scheduling, jobsites, payroll, or communication;
receiving, over a network, vehicle data from at least one of an account holder device, at least one employee device, and at least one employee device, the vehicle data comprising a vehicle identifier, time of arrival, and service request parameters;
registering the vehicle data within a tracking module and associating it with a unique service ticket;
tracking the location and service status of the vehicle in real-time using a location module in operable communication with the tracking module;
updating the service record within the database module based on the vehicle's progress through valet service stages; and
registering and tracking the vehicle data vehicles in real-time via a tracking module.

12. The method of claim 1, further comprising at least one remote source in operable communication with each of the account holder device, the at least one employee device, and the at least one user device.

13. The method of claim 11, wherein the tracking module is operable to manage the customer payment systems, the payroll, and the parking statistics.

14. The method of claim 11, further comprising a location module to monitor the location of the user, a vehicle, or an employee.

15. The method of claim 11, wherein the tracking module and the location module permit the management of a valet service owner, a valet service employee, and a valet service customer.

16. The method of claim 11, wherein the tracking module and the location module permit the tracking of vehicles in real-time.

17. The method of claim 11, further comprising a retail shop for the account holder to purchase valet equipment.

18. The method of claim 11, further comprising the step of managing ticketless parking voucher transactions.
